(19) United States
(12) Patent Application Publication
(10) Pub. No.: US 2021/0163827 A1
(43) Pub. Date: Jun. 3, 2021

(54) CATALYSTS FOR CO2 HYDROGENATION

(71) Applicant: King Abdullah University of Science and Technology, Thuwal (SA)

(72) Inventors: Jean-Marie BASSET, Thuwal (SA); Kuo-Wei HUANG, Thuwal (SA); Amol M. HENGNE, Thuwal (SA); Linga Reddy ENAKONDA, Thuwal (SA)

(21) Appl. No.: 16/772,947

(22) PCT Filed: Dec. 18, 2018
(86) PCT No.: PCT/IB2018/060258

§ 371 Date: Jun. 15, 2020

Related U.S. Application Data
(60) Provisional application No. 62/599,960, filed on Dec. 18, 2017.
(60) Provisional application No. 62/662,299, filed on Apr. 25, 2018.

(51) Int. Cl. C10G 2/00; B01J 6/00; B01J 37/00; B01J 21/04; B01J 23/745; B01J 23/78; B01J 35/02

(52) U.S. Cl. CPC C10G 2/33; C10G 2/50; B01J 6/001; B01J 35/023; B01J 21/04; B01J 23/745; B01J 23/78; B01J 37/0036

(57) ABSTRACT

Embodiments of the present disclosure describe methods of preparing pre-catalysts that may be activated under methane to form catalysts for the hydrogenation of carbon dioxide to form olefins, among other chemical species. Embodiments of the present disclosure also describe methods of preparing catalysts and pre-catalysts, catalyst and pre-catalyst compositions, and methods of producing one or more chemical species using catalysts.

### BACKGROUND

Carbon dioxide is widely emitted from fossil fuels into the Earth's atmosphere and responsible for the greenhouse gas effect. To reduce undesirable carbon dioxide emissions, carbon dioxide may be captured and used for the production of fuels and chemicals. Currently, the conversion of carbon dioxide (CO₂) to various chemicals using homogeneous, heterogeneous, photo- or electro-catalysts has garnered great interest both in industry and academics. The literature has reported many examples of converting CO₂ to commercially useful chemicals. For example, CO₂ mixed syngas (CO+H₂) has been used as a feedstock for the production of methanol and dimethyl ether.

Ongoing research has been directed at developing catalysts for the hydrogenation of carbon dioxide to produce other useful chemicals such as light olefins. In general, CO₂-Fischer-Tropsch synthesis (FT) consists of two steps: a reverse water gas shift reaction to CO and then subsequent hydrogenation to hydrocarbons, which closely resembles the classical Fischer-Tropsch synthesis (FT). While Co and Fe catalysts have been studied for CO₂ hydrogenation reactions, the use of CO₂ and H₂ feed with Co or Fe catalysts leads as a methanation catalyst rather than Fischer-Tropsch (FT) catalysts for the production of hydrocarbons.

It is known that the methods used to prepare catalysts have a considerable influence on catalytic performance Conventional supported Fe oxide/mixed Fe oxide catalysts are prepared by impregnation, co-precipitation by aqueous ammonia, and hydrothermal synthesis. However, the reported methods are multi-step and time-consuming procedures, and require different solvents, toxic chemicals, and expensive precursors.

Before testing their performance for CO₂ hydrogenation, conventional catalysts are reduced under high-purity premixed 5-100% H₂ (in Ar/N₂) at 400-900° C. for several hours. In some reports, an activation method for carbonization of iron catalysts prior to the CO₂ hydrogenation includes using CO/H₂ mixtures at 300-500° C. A disadvantage of many of these existing methods of activating iron-based catalysts under H₂ is that they tend to form FeO, Fe₃C phase that requires very expensive and flammable H₂, toxic CO (carbonization case), and several hours to activate the catalyst. These conventional methods are not suitable for olefin synthesis from an economical perspective. Additionally, the reduction under hydrogen at high temperatures can lead to catalyst sintering problems, which alters the reaction and results in low conversion and selectivity.

Accordingly, it would be desirable to develop a catalyst for CO₂-hydrogenation reactions for the production of olefins that may be easily prepared and readily activated with high conversion and selectivity.

### SUMMARY

In general, embodiments of the present disclosure describe pre-catalysts and catalysts, methods of preparing pre-catalysts and catalysts, and methods of producing chemical species using the catalysts.

Accordingly, embodiments of the present disclosure describe methods of preparing pre-catalysts comprising grinding one or more of a metal precursor, a promoter precursor, and a support precursor; and calcining to form a pre-catalyst. The method may optionally further comprise reducing a grain size or particle size of the pre-catalyst.

Embodiments of the present disclosure describe methods of preparing catalysts comprising flowing methane over a pre-catalyst to form the catalyst.

Embodiments of the present disclosure describe methods of preparing catalysts from pre-catalysts comprising grinding one or more of a metal precursor, a promoter precursor, and a support precursor; calcining to form a pre-catalyst; and flowing methane over the pre-catalyst to form the catalyst. The method may optionally further comprise reducing a particle size of the pre-catalyst.

Embodiments of the present disclosure describe methods of preparing catalysts from pre-catalysts comprising grinding one or more of Fe(NO₃)₃.9H₂O, Na(NO₃)₃, and Al(NO₃)₃.9H₂O to form a homogenous powder mixture; calcining under static air at or to one or more of a first temperature and a second temperature, wherein the first temperature is about 350° C. and the second temperature is about 450° C.; optionally reducing a particle size of the pre-catalyst, wherein the particle size ranges from about 25 μm to about 500 μm; and flowing methane over the pre-catalyst to form the catalyst.

Embodiments of the present disclosure also describe catalysts prepared according to the methods of the present disclosure. The catalysts may include one or more of a metal component, a promoter component, and a support component.

Embodiments of the present disclosure describe methods of producing one or more chemical species comprising flowing a fluid composition including one or more of carbon dioxide and hydrogen over a methane-activated catalyst to produce one or more chemical species; and optionally recovering the one or more produced chemical species.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of preparing a pre-catalyst, according to one or more embodiments of the present disclosure.

FIG. 2 is a flowchart of a method of preparing a catalyst, according to one or more embodiments of the present disclosure.

FIG. 3 is a flowchart of a method of preparing a catalyst from a pre-catalyst, according to one or more embodiments of the present disclosure.

FIG. 4 is a flowchart of a method of preparing a catalyst, according to one or more embodiments of the present disclosure.

FIG. 5 is a flowchart of a method of producing one or more chemical species, according to one or more embodiments of the present disclosure.

FIG. 6 is a graphical view of XRD patterns for 40FeAl catalysts with different temperatures and activation protocols, according to one or more embodiments of the present disclosure.

FIG. 7 is a graphical view of XRD patterns for 5Na38FeAl and 2Ca39FeAl catalysts with different temperatures and activation protocols, according to one or more embodiments of the present disclosure.

FIGS. 8A-8B are HRTEM Images of 40FeAlCH4 at different length scales, according to one or more embodiments of the present disclosure.

FIGS. 9A-9B are HRTEM Images of 5Na38FeAlCH4 before reaction at different length scales, according to one or more embodiments of the present disclosure.

FIGS. 10A-10D are HRTEM images of 5Na38FeAlCH4 after reaction, according to one or more embodiments of the present disclosure.

FIG. 11 is a graphical view of H₂-TPR profiles of supported Fe catalysts, according to one or more embodiments of the present disclosure.

FIG. 12 is a graphical view of catalyst screening for CO₂ hydrogenation over iron catalysts (reaction conditions: T=350° C., P=25 bar, gas flow (CO₂/H₂)=25 mL/min, Space velocity 30 lit/g_{cat}·h, CO₂/H₂=1:3, Time, 24 h; note: 40FeAl-a: H₂ reduced, 350° C.; 40FeAl-b: CH₄ reduced, 750, 10 min; 40FeAl-c: CH₄ reduced, 750, 25 min), according to one or more embodiments of the present disclosure.

FIG. 13 is a graphical view of olefin/paraffin ratio of different catalyst systems (reaction conditions: T=350° C., P=25 bar, gas flow (CO₂/H₂)=25 mL/min, Space velocity 30 lit/g_{cat}·h, CO₂/H₂=1:3, Time, 24 h), according to one or more embodiments of the present disclosure.

FIG. 14 is a graphical view showing effect of temperature on CO₂ conversion and products selectivity over 5Na-38FeAl catalyst (reaction conditions: T=300° C.-350° C., P=25 bar, gas flow (CO₂/H₂)=25 mL/min, Space velocity 30 lit/g_{cat}·h, CO₂/H₂=1:3, Time, 24 h), according to one or more embodiments of the present disclosure.

FIG. 15 is a graphical view of CO conversion versus contact time, according to one or more embodiments of the present disclosure.

FIG. 16 is a graphical view of selectivity versus contact time showing contact time study on CO₂ conversion and product selectivity over 5Na38FeAl catalyst (reaction conditions: T=350° C., P=25 bar, Gas flow (CO₂/H₂)=25 ml/min, Space velocity 4.8, 15 and 30 lit/g_{cat}·h, CO₂/H₂=1:3, Time, 24 h), according to one or more embodiments of the present disclosure.

FIG. 17 is a graphical view of conversion versus time in a time on stream study (reaction conditions: T=350° C., P=25 bar, Gas flow (CO₂/H₂)=25 ml/min, Space velocity 4.8 lit/g_{cat}·h, CO₂/H₂=1:3, Time, 24 h), according to one or more embodiments of the present disclosure.

FIG. 18 is a graphical view showing the effect of pre-treatment on CO₂ conversion (reaction conditions: T=350° C., P=25 bar, Gas flow (CO₂/H₂)=25 ml/min, Space velocity 4.8 lit/g_{cat}·h, CO₂/H₂=1:3, Time, 24 h), according to one or more embodiments of the present disclosure.

### DETAILED DESCRIPTION

The invention of the present disclosure relates to novel catalysts and pre-catalysts, methods of preparing catalysts and pre-catalysts, and methods of producing olefins using catalysts obtained from the pre-catalysts. In particular, the invention of the present disclosure relates to pre-catalysts comprising one or more of a metal precursor (e.g., including Fe, Ni, Co, etc.), a promoter precursor (e.g., alkali and/or alkaline metals), and a support precursor. The pre-catalysts may be easily prepared from the precursor materials via a simple one-step fusion method. For example, the pre-catalysts may be formed simply by grinding one or more of a metal precursor, promoter precursor, and support precursor. The grinded precursor materials may be subject to a calcination step to form pre-catalysts.

This is the first disclosure of pre-catalysts that may be activated under methane to form catalysts active in the production of olefins, among other species, via CO₂ hydrogenation reactions. At least one unexpected advantage of the invention of the present disclosure is that the pre-catalysts may be activated via an efficient and quick pre-treatment. In particular, the pre-catalysts may be activated under methane in less than about 25 minutes, without requiring any reductive pre-treatment under hydrogen and/or carbon monoxide. While conventionally an increase in space velocity reduces selectivity, surprisingly, activating the pre-catalysts in this way enhances selectivity, even with higher space velocity. Activating the pre-catalysts in this way may easily and readily form metallic form and the active metal carbide phase of the catalyst, which are active in the formation of hydrocarbons. Activating the pre-catalysts in this way may also exhibit enhanced catalytic performance, including, but not limited to, selectivity, yield, and conversion.

The catalysts described herein are active in the hydrogenation of CO₂ to produce olefins. In particular, the catalysts described herein may be active in the production of straight-chain C2-C9 olefins via CO₂ hydrogenation. CO₂ hydrogenation may generally include two-steps, including reverse water gas shift (RWGS) reaction and subsequent hydrogenation to hydrocarbons, such as olefins, which may closely resemble Fischer-Tropsch (FT) synthesis. In these and related reactions, the catalysts described herein exhibit efficient CO₂ conversion, with high selectivity towards olefins, including light olefins (C2-C4) and higher-chain olefins (C5-C9), while also suppressing unwanted CH₄ formation.

### Definitions

The terms recited below have been defined as described below. All other terms and phrases in this disclosure shall be construed according to their ordinary meaning as understood by one of skill in the art.

As used herein, “precursors” or “precursor materials” may refer collectively to one or more of the metal precursor, promoter precursor, and support precursor.

As used herein, “calcining” refers to heating to or at a high temperature.

As used herein, “grinding” refers to contacting sufficient to bring two or more components into physical contact, or into close or immediate proximity, sufficient to induce a physiological reaction, a chemical reaction, or a physical change. In many embodiments, grinding is a form of contacting solid or partially solid components.

As used herein, “flowing” refers to contacting sufficient to bring two or more components into physical contact, or into close or immediate proximity, sufficient to induce a physiological reaction, a chemical reaction, or a physical change. Flowing is a form of contacting gaseous components with a component in any phase (e.g., gas/vapor, liquid, or solid phase).

As used herein, “recovering” refers to obtaining any product resulting from a reaction. The product may include the product and one or more other chemical species. The product may also be an isolated product without any impurities, with a low concentration of impurities, or with a negligible concentration of impurities.

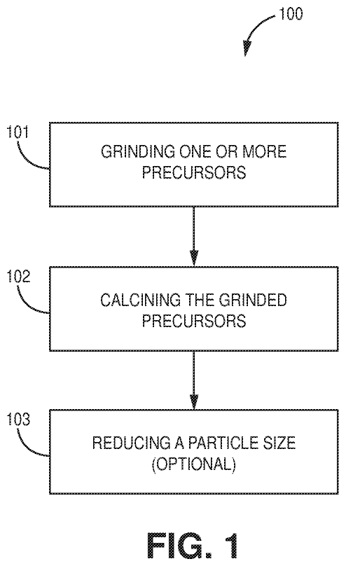

FIG. 1 is a flowchart of a method of preparing a pre-catalyst, according to one or more embodiments of the present disclosure. As shown in FIG. 1, the method may comprise grinding 101 one or more of a metal precursor, a promoter precursor, and a support precursor, and calcining 102 to form a pre-catalyst. The method may optionally further comprise reducing 103 a grain size or particle size of the pre-catalyst. The method 100 may be used to form a pre-catalyst from one or more precursors via a fusion method (e.g., fusing of components, fusion synthesis, fusion of nitrates, etc.)

At step 101, one or more of a metal precursor, promoter precursor, and support precursor are grinded. The grinding may include any technique known in the art for bringing one or more components into physical contact, or immediate or close proximity. For example, the grinding may include physical grinding of precursor materials using a mortar and pestle, ball mill, or the like. The grinding may proceed continuously or non-continuously. The grinding may be sufficient to form a homogenous mixture or an inhomogeneous mixture from the precursor materials. In many embodiments, the grinding may proceed continuously to form a homogenous powder mixture from the precursor materials.

The precursor materials may include one or more of a metal precursor, a promoter precursor, and a support precursor. The precursor materials may be present in a solid or liquid phase, a substantially solid or liquid phase, and/or a partially solid or liquid phase. In some embodiments, the metal precursor, promoter precursor, and support precursor are each salts including an anion, such as nitrate, among others as described herein. In some embodiments, the metal precursor, promoter precursor, and support precursor mixture is fused.

The metal precursor may include any metal (e.g., elemental metal) or metal-containing compound or material suitable for forming an active phase of the catalyst. For example, the metal of the metal precursor may include one or more of iron, cobalt, and nickel. The metal precursor may include or be present as one or more of metal oxides, metal hydroxides, metal carbonyls, metal nitrates, metal oxalates, metal halides, metal sulphates, and naturally occurring metal, in hydrated and/or non-hydrated forms thereof. For example, the metal precursor may include one or more of iron oxides (e.g., Fe₃O₄, FeO, Fe₂O₃, etc.), iron hydroxides, iron carbonyls iron nitrates, iron oxalates, iron chlorides, iron sulfates, iron ore, cobalt oxides, cobalt hydroxides, cobalt carbonyls, cobalt nitrates, cobalt oxalates, cobalt halides, cobalt sulfates, nickel oxides, nickel hydroxides, nickel carbonyls, nickel nitrates, nickel oxalates, nickel halides, and nickel sulfates. In a preferred embodiment, the metal precursor includes one or more of iron nitrate (e.g., Fe(NO₃)₃) and hydrated iron nitrate (e.g., Fe(NO₃)₃.H₂O).

The promoter precursor may include any alkali metal and/or alkaline earth metal. For example, the alkali metal and/or alkaline earth metal of the precursor material may include one or more of lithium, sodium, potassium, rubidium, caesium, francium, beryllium, magnesium, calcium, strontium, barium, and radium. In many embodiments, the alkali metal and/or alkaline earth metal includes one or more of sodium, calcium, potassium, and caesium. The promoter precursor may include or be present as one or more of metal oxides, metal hydroxides, metal nitrates, metal oxalates, metal halides, metal sulphates, naturally occurring metal, and hydrated and/or non-hydrated forms thereof. In many embodiments, the promoter precursor includes one or more of alkali metal nitrates and alkaline metal nitrates. In a preferred embodiment, the promoter precursor includes sodium nitrate (e.g., Na(NO₃)₃).

The support precursor may include any element, compound, or material suitable for forming a catalyst support. Any support precursors suitable for forming one or more of Al₂O₃, SiO₂, TiO₂, ZrO₂, MgO, carbon, carbon nanotubes, and graphene may be used herein. The support precursor may include one or more of aluminum, silicon, titanium, zirconium, magnesium, and carbon. The support precursor may include or be present as one or more of oxides, hydroxides, nitrates, oxalates, halides, and sulfates, in hydrated and/or non-hydrated forms thereof. In some embodiments, the support precursor may be selected based on catalytic performance, such as activity and/or selectivity. In a preferred embodiment, the support precursor is aluminum nitrate (e.g., Al(NO₃)₃) or hydrated aluminum nitrate (e.g., Al(NO₃)₃.9H₂O).

At step 102, the grinded precursor materials may be calcined to form a pre-catalyst. Calcining generally includes heating to or at a high temperature. Calcining may include heating under static air to or at one or more temperatures and may optionally include a temperature ramp (e.g., 5° C./min). For example, the one or more temperatures may range from about 350° C. to about 450° C. In other embodiments, the calcining may proceed to or at temperatures of at least about 100° C. In many embodiments, calcining may proceed to or at temperatures of at least about 300° C. In a preferred embodiment, calcining may proceed to or at a temperature of about 350° C. In another preferred embodiment, calcining may proceed to or at a temperature of about 450° C. In a more preferred embodiment, calcining may proceed to or at a first temperature of about 350° C. and to a second temperature of about 450° C.

At optional step 103, a particle size or grain size of the pre-catalyst may be reduced. A particle size of the pre-catalyst may be reduced via grinding as described above with respect to step 101. The particle size may range from about 25 μm to about 500 μm. In many embodiments, the particle size may range from about 25 μm to about 300 μm. In other embodiments, the particle size may be less than about 25 μm or greater than about 500 μm.

In an embodiment, the method of preparing a catalyst may comprise grinding one or more of a metal precursor, a promoter precursor, and a support precursor to form a mixture (e.g., homogenous mixture); calcining the mixture at one or more temperatures to form a pre-catalyst; and flowing methane over the pre-catalyst to form a catalyst active in the production of olefins via CO₂ hydrogenation.

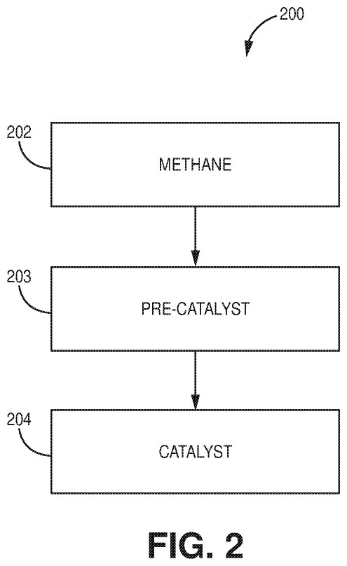

FIG. 2 is a flowchart of a method of preparing a catalyst, according to one or more embodiments of the present disclosure. In many embodiments, the methods may include preparing catalysts obtained from the pre-catalysts described herein and/or prepared according to the methods of the present disclosure. For example, as shown in FIG. 2, the method may comprise flowing 201 methane 202 over a pre-catalyst 203 to form 203 the catalyst 204 (e.g., activated catalyst). The pre-catalyst 203 from which the catalyst 204 is obtained may include any of the pre-catalysts described in the present disclosure and/or prepared according to the methods of the present disclosure. The catalyst, upon activation, may be used for the production of olefins via CO₂ hydrogenation reactions.

The methane 202 may be flowed 201 over the pre-catalyst 203 to form a catalyst 204 (e.g., activated catalyst). The flowing may include any technique known in the art for bringing methane and the catalyst into physical contact, or immediate or close proximity. The flowing may proceed in various types of reactors, including, but not limited to, one or more of a fixed bed reactor, fluidized bed reactor, moving bed reactor, slurry reactor, and other reactors known in the art. In an embodiment, flowing may proceed in an isothermal reactor at atmospheric pressure at one or more temperatures for a select period of time. For example, flowing may proceed in an isothermal reactor at atmospheric pressures at about 750° C. until species are reduced. The temperature may range from about 500° C. to about 1000° C. and/or at a pressure ranging from about 1 bar to about 20 bar for a period ranging from about 1 min to about 1 h. In many embodiments, the catalyst may be formed (e.g., activated) quickly relative to conventional catalysts. For example, the catalyst may be activated in about 10 to about 25 minutes. These shall not be limiting as other temperatures, durations, reduction times, pressures, reactors, and other conditions may be used herein.

The methane that is flowed over the pre-catalyst may further include hydrogen so as to form a methane/hydrogen mixture. The methane/hydrogen mixture may also be used to reduce metal oxides to metallic metals and/or provide a carbon source for forming metal carbides. The methane/hydrogen mixture and/or natural gas may be used as a source for forming metal carbides.

While not wishing to be bound to a theory, methane may provide a source of hydrogen and carbon suitable for activating the pre-catalyst and forming the catalyst. In particular, methane may provide a hydrogen source suitable for reducing certain chemical species of the pre-catalyst. In addition or in the alternative, methane may provide a carbon source suitable for forming catalytically active phases of the catalyst. For example, methane may provide a hydrogen source suitable for reducing metal oxides to, for example, metallic species and a carbon source suitable for forming metal carbides, among other species. In an embodiment, methane may provide a hydrogen source suitable for reducing iron oxide to metallic iron and a source of nanocarbon for forming iron carbide (e.g., Fe₃C, Fe₅C₂, etc.) phases.

The catalyst may include a metal content ranging from about 10 wt. % to 100 wt. %, a promoter content ranging from about 0 wt. % to about 20 wt. %, and a support content ranging from about 0 wt. % to about 90 wt. %.

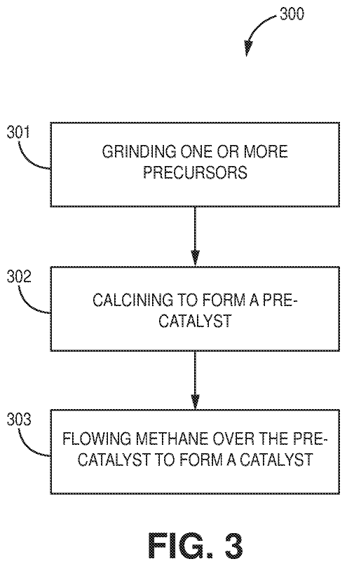

In an embodiment, the methods 100 and 200 may be combined to provide a method of preparing catalysts from the pre-catalysts described herein and/or prepared according to the methods of the present disclosure. The method may include one or more steps from the methods 100 and 200. For example, FIG. 3 is a flowchart of a method 300 of preparing a catalyst from a pre-catalyst, according to one or more embodiments of the present disclosure. As shown in FIG. 3, the method may comprise grinding 301 one or more of a metal precursor, a promoter precursor, and a support precursor; calcining 302 to form a pre-catalyst; and flowing 303 methane over the pre-catalyst to form a catalyst active in the production of olefins via CO₂ hydrogenation. The method may optionally further comprise reducing 304 (not shown) a particle size of the pre-catalyst. In many embodiments, step 304 may proceed after the calcining step 302 and/or before the flowing step 303. The steps of grinding, calcining, reducing, and flowing may be performed as described above with respect to the methods 100 and 200, the discussion of which is hereby incorporated by reference in its entirety.

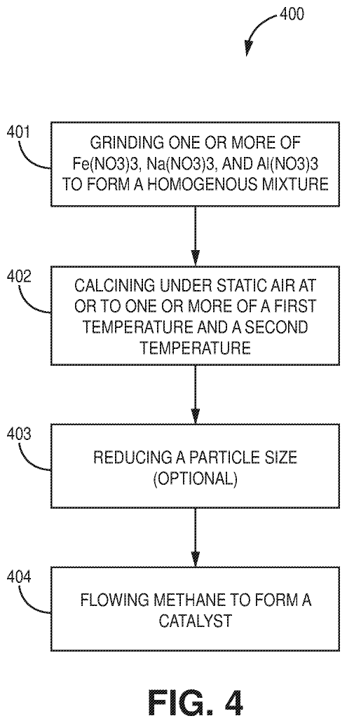

FIG. 4 is a flowchart of a method of preparing a catalyst (e.g., by nitrate fusion synthesis), according to one or more embodiments of the present disclosure. As shown in FIG. 4, the method 400 may comprise grinding 401 one or more of Fe(NO₃)₃.9H₂O, Na(NO₃)₃, and Al(NO₃)₃.9H₂O to form a homogenous powder mixture; calcining 402 under static air at or to one or more of a first temperature and a second temperature; optionally reducing 403 a particle size of the pre-catalyst; and flowing 404 methane over the pre-catalyst to form the catalyst. In an embodiment, the first temperature is about 350° C. and the second temperature is about 450° C. In an embodiment, the particle size ranges from about 25 μm to about 500 μm. The steps of grinding, calcining, reducing, and flowing may be performed as described above with respect to the methods 100, 200, and 300, the discussion of which is hereby incorporated by reference in its entirety.

Embodiments of the present disclosure also describe catalysts prepared according to the methods of the present disclosure. The catalysts may include one or more of a metal component, a promoter component, and a supporter component.

The metal component may include one or more of iron, cobalt, and nickel. The metal component may exist or be present as one or more of metal oxides, metal hydroxides, metallic metals, and metal carbides. In a preferred embodiment, the metal component may include iron and exist or be present as one or more of iron oxides, iron hydroxides, metallic iron, and iron carbides (e.g., Fe₃C, Fe₅C₂, etc.). In other embodiments, the metal component may include one or more of cobalt and nickel, which may exist or be present as described herein. A content of metal or the metal component included in the catalyst may range from about 10% to about 100% (w/w) based on total weight of the catalyst. In many embodiments, a content of metal or the metal component included in the catalyst may range from about 40% to about 100% (w/w) based on total weight of the catalyst.

The promoter component may include one or more of alkali metals and alkaline metals. Any of the alkali metals and alkaline metals described herein may be included here. In many embodiments, the promoter component may include one or more of sodium, calcium, caesium, and potassium. A content of the promoter or promoter component may range from about 0% to about 20% (w/w) based on the total weight of the catalyst. In many embodiments, a content of the promoter or promoter component may range from about 1% to about 20% (w/w) based on the total weight of the catalyst. In a preferred embodiment, a content of the promoter or promoter component may range from about 2% to about 10% (w/w) based on the total weight of the catalyst.

The support component may include one or more of aluminum, silicon, titanium, zirconium, magnesium, and carbon. In some embodiments, the support component may exist or be present as elemental chemical species (e.g., carbon) and compounds with varying structures, oxides, mixed oxides, hydroxides, and other oxygenated species. For example, in an embodiment, the support component may include one or more of Al₂O₃, SiO₂, TiO₂, ZrO₂, MgO, carbon, carbon nanotubes, and graphene. In a preferred embodiment, the support component may include aluminum and may exist or be present as one or more of aluminum oxide, aluminum hydroxide, metal aluminate (e.g., Fe aluminate), and γ-alumina. A content of the support or support component may range from about 0% to less than about 100% (w/w) based on the total weight of the catalyst. In many embodiments, a content of the support or support component may range from about 90% to about 100% (w/w) based on the total weight of the catalyst.

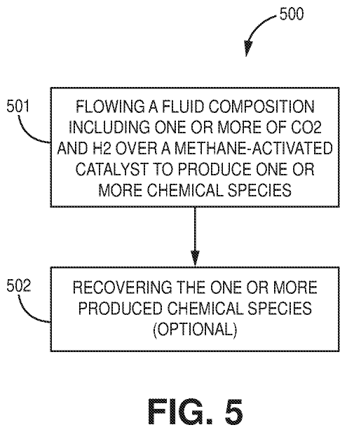

FIG. 5 is a flowchart of a method of producing one or more chemical species, according to one or more embodiments of the present disclosure. As shown in FIG. 5, the method 500 may comprise flowing 501 a fluid composition including one or more of carbon dioxide and hydrogen over a methane-activated catalyst to produce one or more chemical species; and optionally recovering 502 the one or more produced chemical species.

At step 501, at least carbon dioxide and hydrogen are flowed over a methane-activated catalyst to produce one or more chemical species. Flowing may include bringing one or more chemical species of a fluid composition into physical contact with, or immediate or close proximity to, a catalyst sufficient to bring about a reaction in the presence of the catalyst. Examples of flowing may include charging, feeding, passing, and other techniques known in the art for flowing.

The flowing may proceed at any suitable reaction temperature and pressure, and the reaction may proceed in a variety of reactors. In many embodiments, the temperature may range from about 150° C. to about 450° C. and/or the H₂ pressure may range from about 5 bar to about 25 bar. In other embodiments, the temperature may be less than about 200° C. and/or greater than about 400° C., and the pressure may be less than about 5 bar and/or greater than about 25 bar. A space velocity range may be between a space velocity of about 5 lit/g_{cat}·h to about 100 lit/g_{cat}·h. The reactors may include any suitable reactor. In many embodiments, the reactor may include one or more of a fixed bed reactor, fluidized bed reactor, moving bed reactor, slurry reactor, and any other suitable reactor known in the art.

The fluid composition may include one or more of carbon dioxide and hydrogen. In many embodiments, the fluid composition includes carbon dioxide and hydrogen for CO₂ hydrogenation reactions. A ratio of hydrogen to carbon dioxide may be about 0.1:10. In many embodiments, a ratio of hydrogen to carbon dioxide may be about 1:3.

The methane-activated catalyst may include any of the catalysts described herein and/or prepared according to the methods of the present disclosure. For example, in many embodiments, the methane-activated catalyst is a catalyst obtained from the pre-catalysts described herein and activated under methane to provide the methane-activated catalyst.

The one or more chemical species produced may include one or more olefins. The olefins may include light olefins (C2-C4) and/or higher chain olefins (C5-C9). In many embodiments, the one or more chemical species produced may include straight chain olefins (C2-C9). For example, in an embodiment, the one or more chemical species produced may include one or more of ethylene, propylene, butylene, and derivatives thereof. In other embodiments, the one or more chemical species produced may include one or more of methane, dimethyl ether, synthetic fuels, ketones, aldehydes, and alcohols.

At optional step 502, the one or more produced chemical species is recovered. Recovering generally includes obtaining any product (e.g., the one or more produced chemical species) resulting from a reaction. The one or more produced chemical species recovered may be isolated without any impurities (e.g., undesirable by products), with a low concentration of impurities, or with a negligible concentration of impurities. In many embodiments, the one or more produced chemical species include olefins (e.g., C2-C9). In a preferred embodiment, the one or more produced chemical species includes straight chain olefins.

The promoter component may include one or more promoters. The promoter component may be used for a variety of reasons. For example, the promoter component may be used to minimize methane formation during CO₂ hydrogenation, reduce an active metal component, and/or improve basic strengths of the catalyst.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### EXAMPLE 1

Carbon dioxide is widely emitted from fossil fuels into the Earth's atmosphere and responsible for the greenhouse gas effect. To reduce undesirable carbon dioxide emissions, carbon dioxide may be captured and used for the production of fuels and chemicals. Currently, the conversion of carbon dioxide (CO₂) to various chemicals using homogeneous, heterogeneous, photo- or electro-catalysts has garnered great interest both in industry and academics. The literature has reported examples of converting CO₂ to commercially useful chemicals. For example, CO₂ from syngas has been used as a feedstock for the production of methanol and dimethyl ether. Ongoing research includes developing active and selective catalysts for hydrogenation of CO₂ to synthetic fuels, light olefins, ketones, aldehydes and higher alcohols.

CO₂-hydrogenation mainly consists of two steps: reverse water gas shift reaction to CO and then subsequent hydrogenation to hydrocarbons, which closely resembles classical Fischer-Tropsch (FT) synthesis. FT synthesis may proceed over Co, Fe and Co—Fe based catalytic systems, in the form of bulk or supported oxide catalysts. Iron-based materials may provide the two catalytic functions—iron oxide or mixed oxide phases for the reverse water gas shift (RWGS) reaction and the iron carbide phase for FT synthesis required for this process.

Conventionally, use of CO₂ and H₂ feed with Co or Fe catalysts leads as methanation catalysts rather than FT catalysts. In order to minimize unwanted methane formation, catalysts may be promoted with alkali dopants, such as K, Na, and Cs. Use of the alkali promoters may effectively help to reduce bulk FeOx, Co-oxide species, and improve catalyst basic strengths. Iron catalysts may be cheap and active for FT synthesis but the target material need to be investigated on the basis of active metal, easy reducibility, and formation of active iron carbide species. Fe catalysts may be favorable for irreversible carbiding with alkali surface coverage, while in case of cobalt catalysts there may be strong reversible CO adsorption. Furthermore, syngas (CO/H₂) conversion may occur without primary reduction of catalysts, while, in case of CO₂, the use of H₂ requires reduction of catalysts.

With respect to previous technologies, iron oxide and cobalt oxide catalysts have been used as FT catalysts. Such catalysts are also active in both WGS and RWGS reactions. Especially iron-based catalysts are attractive for the hydrocarbons synthesis due to the highly olefinic nature of the obtained products. Different support materials have been tried for Fe-based catalysts. Among the oxides (Al₂O₃, SiO₂, TiO₂, MgO and different zeolite supports) alumina has exhibited better performance in terms of activity and low methane selectivity.

It has been well known that the catalysts preparation methods have a considerable influence on the catalytic performance In the literature, researchers have prepared supported Fe oxide/mixed Fe oxide catalysts by impregnation, co-precipitation by aqueous ammonia method, and hydrothermal synthesis methods. However, these reported procedures are multi-step and are time-consuming procedures and require different solvents and chemicals, as well as expensive precursors.

In the literature reports, before testing their catalyst performance for the CO₂ hydrogenation, the catalysts were reduced under high-purity premixed 5-100% H₂ (in Ar/N₂) at 400-900° C. for several hours. Others have reported an activation method for carbonization for iron catalysts prior to the CO₂ hydrogenation by using CO/H₂ mixture at 300-500° C. A disadvantage of many of these existing methods of activating iron-based catalysts under H₂ is that they tend to form Fe⁰, Fe₃C phases that require very expensive and flammable H₂, toxic CO (carbonization case) and that need several hours to activate the catalyst, which is not suitable for olefin synthesis from an economical point of view. Additionally, the reduction under hydrogen at high temperatures can lead to catalyst sintering problems, which alter the reaction with low conversion and selectivity.

The range of conversion levels can be explained in the existing methods by the different reactors and different catalysts, as well as experimental conditions. Catalysts formulations containing iron oxide with alkali promoters (K and Na) were tested for CO₂ hydrogenation to lower olefins at temperatures ranging between 200-750° C. It is reported that methane is thermodynamically the most favored hydrocarbon product, while olefin selectivity in the C2-C5+ range of around 5-50% is commonly reported. The conversion of CO₂ was reported in the range of 2-60%.

In the present Example, methane is used instead of Hydrogen to reduce the catalyst. A method of forming straight chain olefins using a single-step catalytic hydrogenation of carbon dioxide is proposed. The catalyst comprises iron, sodium as alkali promoter and alumina (Al₂O₃). The iron component can exist in the form of elemental iron, iron oxide, iron carbide (Fe₃C, Fe₅C₂), multiwall carbon nanotubes (MWCNTs), and/or iron aluminate. The preferred catalyst composition is approximately 40 to 100 weight percent iron based on the total weight of the catalyst. The alkali promoter (Na) component in the catalyst is in the range of about 2 to 10%, and preferably in its metallic form. Alumina (Al₂O₃) acts as a support. Here, an efficient catalyst with single step preparation procedure is developed, with no previous reduction by hydrogen. But surprisingly activation can be made by methane.

Compared with conventional methods reported in the literature, the one step fusion (fusing of nitrates) synthesis method has many advantages such as precise stoichiometric ratio, homogeneous component, low cost and short reaction time. Therefore, it has been an attractive technique for the synthesis of supported metal powders especially for application in industrial chemical reactions.

After physically grinding the mixture of alkali metal nitrate, Fe(NO₃)₃.9H₂O, Na(NO₃)₃ and Al(NO₃)₃.9H₂O, the samples were calcined under static air from room temperature to 350° C. for 3 h with a 5° C./min ramp, then further to 450° C. for 8 h with a 5° C./min ramp. The samples were then cooled down to room temperature. Finally, the sample was ground to fine powder.

The catalyst activation was performed in a fixed bed/fluidized bed isothermal reactor at atmospheric pressure. Each M-Fe—Al₂O₃ (M-alkali metal) catalyst with 50-300 μm grain size was loaded into the reactor and heated to 750° C. under nitrogen flow. After reaching the temperature to 750° C. (stable) the gas flow was switched to methane to reduce the catalysts and the reduction time was about 10-25 min. Then the reactor was cooled down to room temperature under N₂ flow. Methane activation acted as a source of hydrogen, which was required for reducing iron oxide to metallic iron. At the same time, carbon source in terms of nano-carbon was obtained from the carbon of methane, which was key for the formation of the iron carbide (Fe₃C and Fe₅C₂) phases. It was highly important that the iron carbide phase be formed, which is a known active catalytic phase for the formation of heavier hydrocarbons in FT synthesis. The alkali promoter Na in combination with iron offered high activity and selectivity for the single step production of straight chain olefins (C2-C9) via CO₂ hydrogenation.

Catalytic results of CO₂ Hydrogenation: The gas hourly space velocity (GHSV) in the range of about 4800-30000 L/Kg·h⁻¹ carbon dioxide-containing feed (hydrogen and carbon dioxide in 1:3 ratio) was charged to the reactor. In a typical procedure, H₂ pressure was between about 5-25 bar and the reaction temperature was preferably maintained in the range of about 200-400° C. Three main advantage of the present invention for the process of catalytic hydrogenation of carbon dioxide to olefins and oxygenate are (a) easily prepared catalysts compositions along with suitable alkali metals; (b) efficient and quick pretreatment conditions under methane to get carbon and H₂ source led to both metallic iron and iron carbide phases; and (c) alkali promoted iron carbide catalyst exhibited efficient conversion of CO₂ (e.g., about 28%) with combined selectivity to light olefin (C2-C4) and higher chain olefins (C5-C9) (e.g., about 50-60%).

Light olefins (ethylene, propylene and butylene) are widely used as starting materials for the production of various plastics such as polystyrene, polyvinyl chloride, and polyethylene terephthalate, which are commonly used in packing material, synthetic textile, and coatings. The alkali-modified Fe-based catalysts described herein can easily prepared and pretreated. Use of low cost Fe catalysts are active in CO₂ hydrogenation for the production of olefins with efficient activity and selectivity. Usually production of hydrocarbons from CO₂ instead of CO is energy intensive process. Here, however, the catalysts described herein showed efficient CO₂ conversion with high selectivity to olefins by suppressing unwanted CH₄ formation over a heterogeneous catalyst in a single step.

The textural properties of all Fe catalysts were listed in Table 1 (below). It can be found that as prepared catalyst (5Na38FeAl-Fresh) showed high surface area around 116 m²/g while, the reduction of Fe catalysts using methane and H₂ as a precursors (5Na38FeAl/CH₄, 5Na38FeAl/H₂) decreased surface area of the catalysts up to three to four fold compared to 5Na38FeAl-Fresh catalyst (about 35 to 19 m²/g). The 40FeAl/CH₄ catalysts without Na promoted also lowered the surface area of the catalyst up to 23 m²/g, which was slightly lower than Na modified Fe catalyst. On other hand, the Ca modified Fe catalysts obtained 61 m²/g surface area of the catalysts. In contrast, the H₂ pretreated catalysts (5Na38FeAl/H₂) contained marginal loss in the pore volume (about 0.064623) of the catalysts as compared to CH₄ pretreated Fe catalysts. As against, the pore size of H₂ and CH₄ pretreated catalysts was increased two times as compared to fresh Fe catalyst.

TABLE 1
Textural Properties of Supported Catalysts

| | BET | | | |
|---|---|---|---|---|
| | surface | | Pore | Crystal |
| | area | Pore | Size | size from |
| Catalysts | (m²/g) | Volume | (Å) | XRD |
| 5Na38FeAl-Fresh | 116 | 0.123524 | 41.714 | 13.57 |
| 5Na38FeAl/CH₄ red | 35 | 0.104330 | 104.801 | 56.31 |
| 5Na38FeAl/H₂ red | 19 | 0.064623 | 118.408 | 112.47 |
| 40FeAl/CH₄ red | 23 | 0.098284 | 149.757 | 56.24 |
| 2Ca39FeAl/CH₄ red | 61 | 0.134219 | 85.392 | 28.15 |

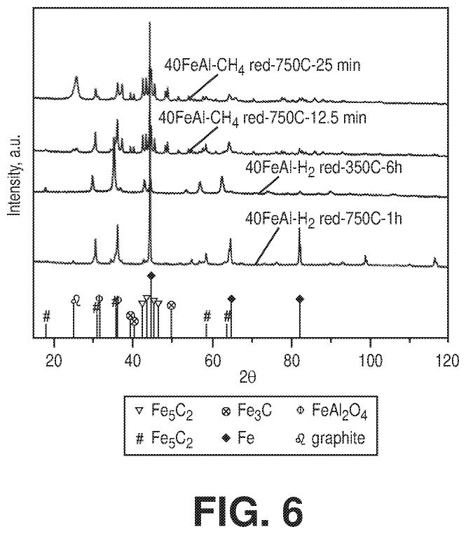

FIG. 6 is a graphical view of XRD patterns for 40FeAl catalysts with different temperatures and activation protocols, according to one or more embodiments of the present disclosure. Different reduction patterns and parameters showed various diffraction phases, which corresponded to Fe₃O₄, Fe, and Fe-carbide phases.

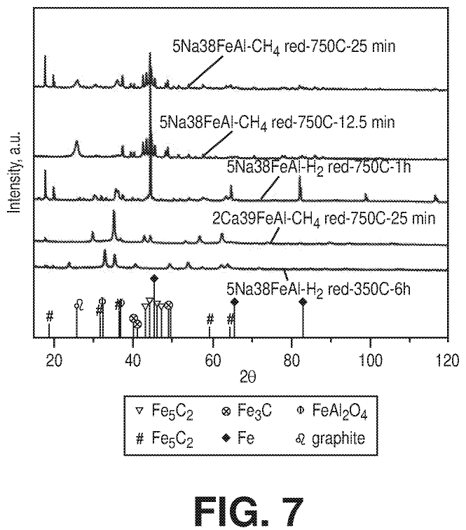

FIG. 7 is a graphical view of XRD patterns for 5Na38FeAl and 2Ca39FeAl catalysts with different temperatures and activation protocols, according to one or more embodiments of the present disclosure. Similarly, the different reduction patterns and parameters showed various diffraction phases, which corresponded to Fe₃O₄, Fe, and Fe-carbide phases.

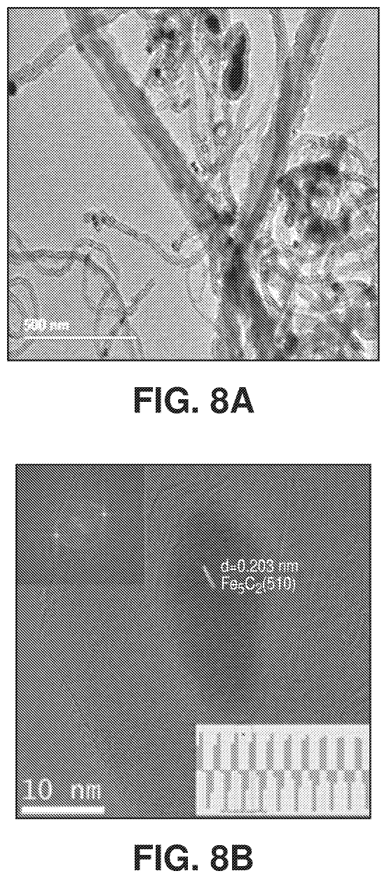

FIGS. 8A-8B are HRTEM Images of 40FeAlCH4 at different length scales, according to one or more embodiments of the present disclosure. An active Fe₅C₂ phase was observed with (510) plane.

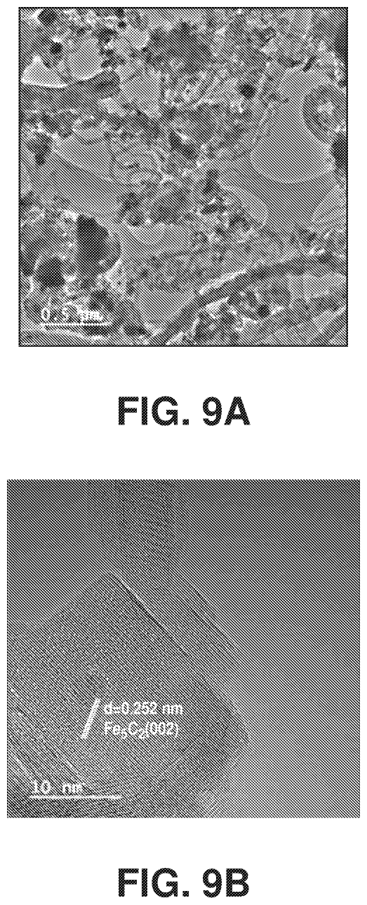

FIGS. 9A-9B are HRTEM Images of 5Na38FeAlCH4 before reaction at different length scales, according to one or more embodiments of the present disclosure. MWCNT-associated Fe-carbide phases were found. Active Fe₅C₂ phase was observed with another phase (002) plane with addition of alkali metals.

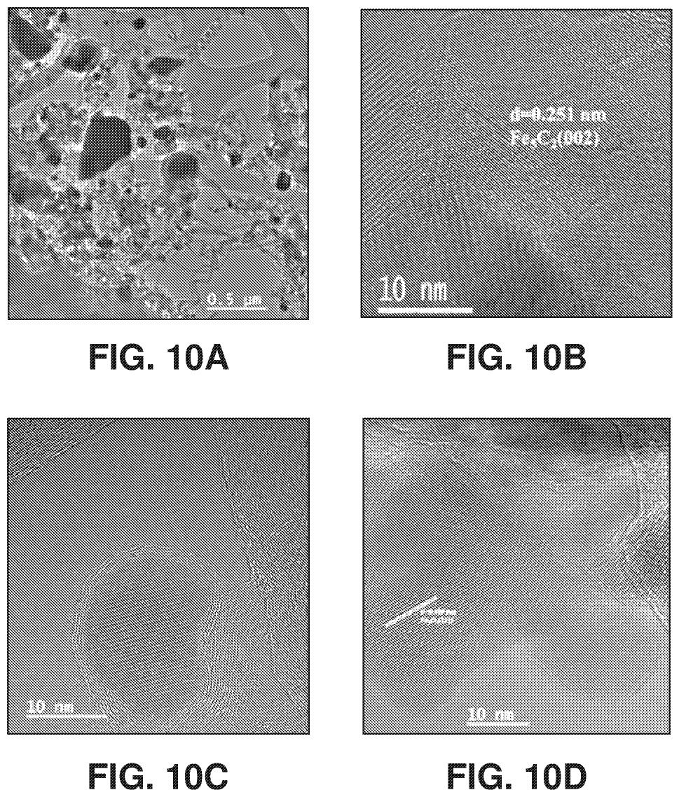

FIGS. 10A-10D are HRTEM images of 5Na38FeAlCH4 after reaction, according to one or more embodiments of the present disclosure. The presence of Fe₃O₄ phase was found and the presence of other phases of Fe oxide and carbide could not be discarded.

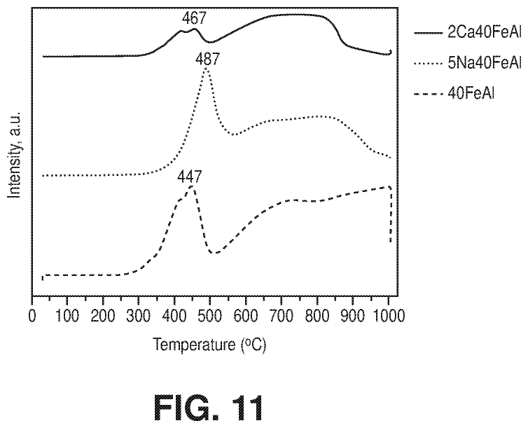

FIG. 11 is a graphical view of H₂-TPR profiles of supported Fe catalysts, according to one or more embodiments of the present disclosure.

In order to find out catalysts active catalysts with high CO₂ conversion and high selectivity to straight chain olefins. Hence, using CH₄ pretreated iron catalysts at 25 min modified with two alkali precursors, Na and Ca screened for CO₂ hydrogenation by keeping similar parameter from FIG. 6. Among screened catalysts 100Fe/C catalysts showed low conversion of CO₂ about 5% with very high selectivity to methane 79% and HCs 17% respectively. While, use of 40FeAl composition for CO₂-FT showed almost more than two fold high in CO₂ conversion 13%, while the selectivity trend is consistent with methane and HCs. Both 100Fe/C and 40FeAl/c after modification of alkali metal Na gave efficient conversion of CO₂ 11% and 14%, respectively. However, use of alkali metal Na showed remarkable change in selectivity pattern with decrease in selectivity to methane 40% with increasing selectivity to straight chain olefins >50% (C2-C9) at very high gas hour space velocity 30 lit/g_{cat}·h. Particularly, the light olefins (C2-C4) selectivity is predominant with addition of alkali metal (Na) and availability of iron carbide phase formation catalysts. Indeed, use of alkaline earth metal Ca with 40FeAl/C did not showed very high conversion of CO₂ along with poor selectivity to olefins formation, which could be due to the lack of Fe carbide phase formations observed from XRD study. So, it can be found that alkali promoter Na associated with iron carbide play vital role for the formation of olefins. These observations are in line with study of olefin to paraffin ratio.

TABLE 2
Catalyst Screening for CO₂ Hydrogenation

| | | Product Selectivity (C mol %, CO Free) | | | | | |
|---|---|---|---|---|---|---|---|
| | Conver- | | | C2-C4 | C2-C4 | C5-C9 | C5-C9 |
| Catalysts | sion, % | | CH₄ | alkanes | olefins | alkanes | olefins |
| 40FeAl | 13 | 14 | 73 | 22 | 3 | 2 | <0.01 |
| 5Na38FeAl | 14 | 58 | 40 | 5 | 47 | 0.02 | 8 |
| 100Fe | 5 | 42 | 79 | 17 | 2 | 2 | <0.01 |
| 5Na98Fe | 11 | 64 | 41 | 5 | 38 | 3 | 12 |
| 2Ca38FeAl | 7 | 17 | 73 | 20 | 5 | 1 | <0.01 |

The reaction conditions included the following: T=350° C., P=25 bar, gas flow (CO₂/H₂)=25 mL/min, space velocity 30 lit/g_{cat}·h, CO₂/H₂=1.3, time=24 h.

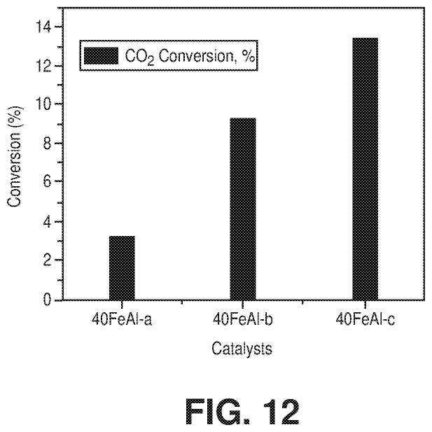

FIG. 12 is a graphical view of catalyst screening for CO₂ hydrogenation over iron catalysts (reaction conditions: T=350° C., P=25 bar, gas flow (CO₂/H₂)=25 mL/min, Space velocity 30 lit/g_{cat}·h, CO₂/H₂=1:3, Time, 24 h; note: 40FeAl-a: H₂ reduced, 350° C.; 40FeAl-b: CH₄ reduced, 750, 10 min; 40FeAl-c: CH₄ reduced, 750, 25 min), according to one or more embodiments of the present disclosure. The catalysts screening were investigated for CO₂ hydrogenation in a fixed bed reactor at 350° C., 25 bar and GHSV of 30 l/g·h. Initially, H₂ pretreated Fe₂O₃ catalysts at 350° C. were tested for CO₂ hydrogenation and showed poor conversion of CO₂ (e.g., about 3%). After changing pre-treatment condition by replacing H₂ to CH₄ at 750° C. for 10 min, simultaneously CO₂ conversion increased to about 9%. Moreover, using methane as precursor required a pre-treatment time of up to 25 min or less, and showed that the conversion of CO₂ was 4 times higher than H₂ pre-treated catalysts at 350° C. This trend for CO₂ conversion activity with iron catalysts for hydrocarbon synthesis may be dependent on iron in metallic form along with the availability of iron carbide phases.

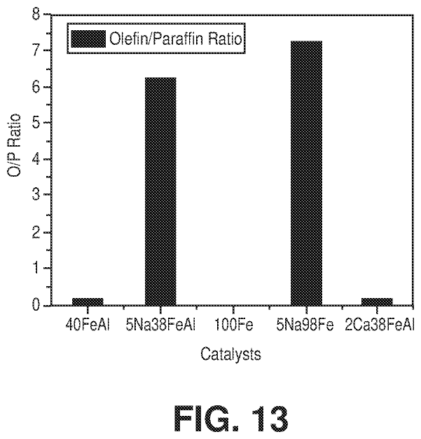

FIG. 13 is a graphical view of olefin/paraffin ratio of different catalyst systems (reaction conditions: T=350° C., P=25 bar, gas flow (CO₂/H₂)=25 mL/min, Space velocity 30 lit/g_{cat}·h, CO₂/H₂=1:3, Time, 24 h), according to one or more embodiments of the present disclosure. These observations were consistent with studies showing olefin to paraffin ratio (FIG. 6). Both Na-modified Fe catalysts (5Na38FeAl and 5Na98Fe) possessed very high olefin to paraffin (O/P) ratio for C2-C4 olefins as compared to the unmodified Fe catalysts (40FeAl, 100Fe).

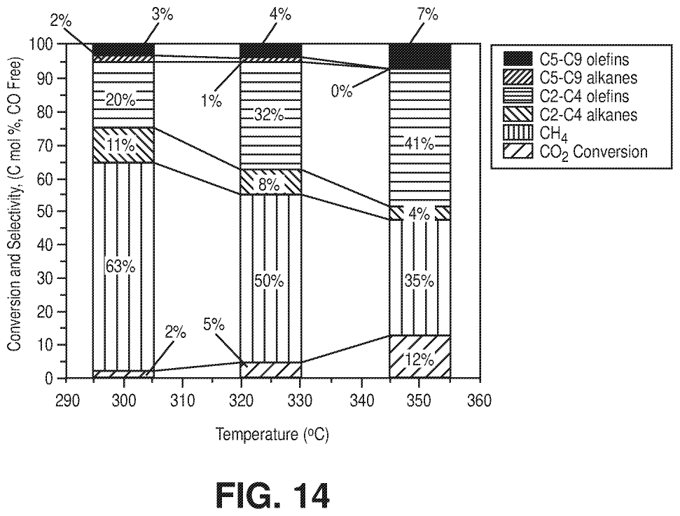

FIG. 14 is a graphical view showing effect of temperature on CO₂ conversion and products selectivity over 5Na-38FeAl catalyst (reaction conditions: T=300° C.-350° C., P=25 bar, gas flow (CO₂/H₂)=25 mL/min, Space velocity 30 lit/g_{cat}·h, CO₂/H₂=1:3, Time, 24 h), according to one or more embodiments of the present disclosure. The effect of reaction temperature on CO₂ conversion and olefin selectivity over 5Na38FeAl catalyst were investigated by keeping all other parameters constant (FIG. 14). It can be found that the CO₂ conversion was increased from 2 to 12% as temperature increased from 300-350° C. However, the selectivity to light olefins (C2-C4) was increased from 20-48% along with improved selectivity in the higher homologue of olefins (C5-C9) up to 7%. In addition, the increased in the reaction temperature 300-350° C. decreased undesired methane selectivity from about 63% to about 35%.

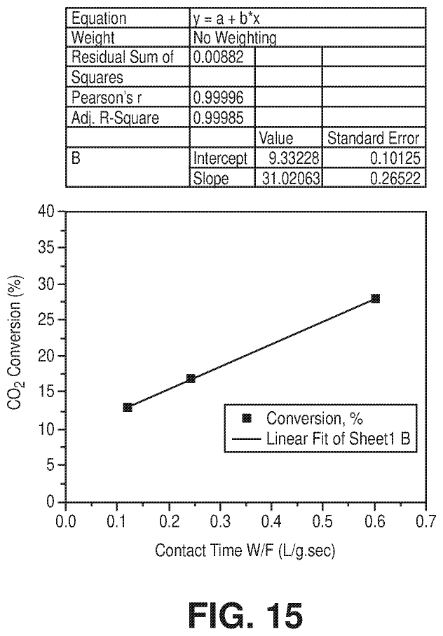

FIG. 15 is a graphical view of CO conversion versus contact time, according to one or more embodiments of the present disclosure.

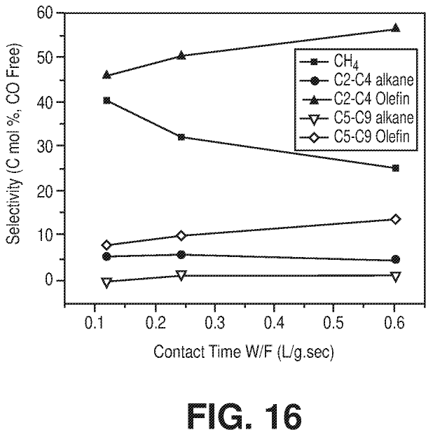

FIG. 16 is a graphical view of selectivity versus contact time showing contact time study on CO₂ conversion and product selectivity over 5Na38FeAl catalyst (reaction conditions: T=350° C., P=25 bar, Gas flow (CO₂/H₂)=25 ml/min, Space velocity 4.8, 15 and 30 lit/g_{cat}·h, CO₂/H₂=1:3, Time, 24 h), according to one or more embodiments of the present disclosure.

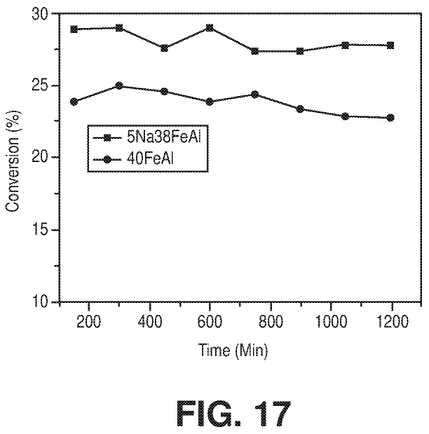

FIG. 17 is a graphical view of conversion versus time in a time on stream study (reaction conditions: T=350° C., P=25 bar, Gas flow (CO₂/H₂)=25 ml/min, Space velocity 4.8 lit/g_{cat}·h, CO₂/H₂=1:3, Time, 24 h), according to one or more embodiments of the present disclosure.

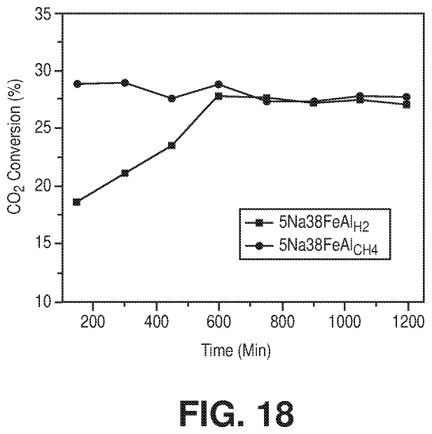

FIG. 18 is a graphical view showing the effect of pre-treatment on CO₂ conversion (reaction conditions: T=350° C., P=25 bar, Gas flow (CO₂/H₂)=25 ml/min, Space velocity 4.8 lit/g_{cat}·h, CO₂/H₂=1:3, Time, 24 h), according to one or more embodiments of the present disclosure. H₂-activated catalysts required more than 500 minutes to gain similar CO₂ conversion activity as compared to methane-activated catalysts.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

1. A method of preparing a catalyst, comprising:
grinding one or more of a metal precursor, a promoter precursor, and a support precursor to form a mixture;
calcining the mixture at one or more temperatures to form a pre-catalyst; and
flowing methane over the pre-catalyst to form a catalyst active in the production of olefins via CO₂ hydrogenation.

2. The method of claim 1, wherein the metal precursor includes one or more of iron, cobalt, and nickel.

3. The method of claim 1, wherein the metal precursor includes one or more of a metal oxide, metal hydroxide, metal nitrate, metal oxalate, metal chloride, metal carbonyl, and metal sulphate.

4. The method of claim 1, wherein the promoter precursor includes one or more of an alkali metal and alkaline earth metal.

5. The method of claim 1, wherein the promoter precursor includes one or more of sodium, calcium, potassium, caesium, manganese, copper, lithium, rubidium, francium, beryllium, magnesium, strontium, barium, and radium.

6. The method of claim 1, wherein the support precursor includes one or more of aluminum, titanium, zirconium, silicon, magnesium, carbon, carbon nanotubes, graphene, zinc, and zeolites.

7. The method of claim 1, wherein the metal precursor, promoter precursor, and support precursor are each salts, wherein an anion of the salt is nitrate.

8. The method of claim 1, wherein the metal precursor, promoter precursor, and support precursor mixture is fused.

9. The method of claim 1, wherein the one or more temperatures range from about 350° C. to about 450° C.

10. The method of claim 1, further comprising reducing a grain size of the pre-catalyst.

11. The method of claim 1, wherein the grain size ranges from about 25 μm to about 500 μm.

12. The method of claim 1, wherein the catalyst includes a metal content ranging from about 10 wt. % to 100 wt. %, a promoter content ranging from about 0 wt. % to about 20 wt. %, and a support content ranging from about 0 wt. % to about 90 wt. %.

13. The method of claim 1, the methane and methane/hydrogen mixture reduces metal oxides to metallic metals and provides a carbon source for forming metal carbides.

14. The method of claim 1, the methane/hydrogen mixture and natural gas also can use a source for forming metal carbides.

15. The method of claim 1, wherein the one or more temperatures range from about 500° C. to about 1000° C., and at a pressure is about 1 bar to 20 bar for a period of 1 min to 1 hour.

16. The method of claim 1, wherein the catalyst is supported on one or more of Al₂O₃, SiO₂, TiO₂, ZrO₂, MgO, carbon, carbon nanotubes, and graphene.

17. A method of preparing a catalyst, comprising:
grinding one or more of Fe(NO₃)₃.9H₂O, Na(NO₃)₃, and Al(NO₃)₃.9H₂O to form a homogenous powder mixture;
calcining under static air at or to one or more of a first temperature and a second temperature; and
flowing methane over the pre-catalyst to form the catalyst.

18. A method of producing chemical species, comprising:
flowing at least carbon dioxide and hydrogen over a methane or methane/hydrogen mixture or natural gas activated catalyst to produce hydrocarbons by CO₂ hydrogenation.

19. The method of claim 18, where in the temperature range from 150 and 450° C., and the space velocity range between about 5 and about 100 lit/g_{cat}·h.

20. The method of claim 18, wherein the hydrocarbons include one or more straight chain C₂ to C₉ olefins.
